(19) United States
(12) Patent Application Publication
(10) Pub. No.: US 2003/0071983 A1
(43) Pub. Date: Apr. 17, 2003

(54) Method for improving resolution limits of a stepper

(76) Inventors: Chi-Yuan Hung, Yiilan Hsien (TW); Ching-Yu Chang, Yilan Hsien (TW); I-Pien Wu, Hsinchu (TW); Chuang-Hui Kuo, Hsien (TW)

Correspondence Address: J.C. Patents, Inc., Suite 250, 4 Venture, Irvine, CA, 92618, US

(21) Appl. No.: 09/990,452

(22) Filed: Nov. 20, 2001

(30) Foreign Application Priority Data
Oct. 12, 2001 (TW) 90125179

(51) Int. Cl. G03B 27/32

(52) U.S. Cl. 355/77; 355/53; 355/67; 355/30

(57) ABSTRACT

A method for improving the resolution limits of a stepper is described. The region between the mask and the projection lens of the stepper is filled with a transparent material, wherein the reflection index of the transparent material is greater than one. Since the reflection index of the transparent material is greater than one, the diffracted angle of the diffracted light, formed after the parallel light from the light source passes through the mask, is reduced. A majority of the diffracted light can thus pass through the projection lens to improve the resolution limits of the stepper.

### CROSS-REFERENCE TO RELATED APPLICATION

This application claims the priority benefit of Taiwan application serial no. 90125179, filed on Oct. 12, 2001.

### BACKGROUNDING OF THE INVENTION

1. Field of Invention

The present invention relates to a lithography process. More particularly, the present invention relates to a method for improving the resolution limits of a stepper in a lithography process.

2. Description of Related Art

The lithography process is an essential step in semiconductor processing, which includes the patterning of the various layers of thin film and the defining of the doped regions. Although a lithography process is rather complicated, the theory behind lithography is simple. Typically, a photosensitive material is formed to cover the wafer. After passing through a mask, the parallel light from a light source hits the photosensitive material. The pattern on the mask is then completely transferred to the photosensitive material on the wafer surface. This process of transferring a pattern on a mask to a photo-sensitive material through a parallel light of a light source is known as exposure.

A most common exposure technique is known as the projection exposure, in which transferring the pattern on a mask is similar to using a projector to project a pattern on a slide to a wallk. Since there is no direct contact between the mask and the wafer in accordance to this exposure method, the pattern on the mask is prevented from being damaged. Moreover, the resolution of the transferred pattern is more desirable. The projection exposure method has evolved to a new generation of the step-and-repeat method. The pattern on the mask used for this type of exposure method, however, is larger than the transferred pattern. During the exposure process, the projected light, after passing through the mask, is reduced by an appropriate ratio and illuminates only a part of the wafer. The patterning of a wafer thus can not complete in a single exposure process. To complete the exposure of an entire wafer, the exposure process is repeated for multiple times to expose the wafer step-by-step.

FIG. 1 illustrates the conventional projection exposure type of stepper.

As shown in FIG. 1, the conventional stepper 120 includes a light source 100, a mask 102 and a projection lens 104, wherein the mask 102 is placed between the light source 100 and the projection lens 104.

Using the stepper 120 to perform an exposure process is summarized as follow. After passing through a mask 102, a parallel light 100a from a light source 100 is diffracted at an angle. The diffracted light 100b, after passing through the projection lens 104, becomes projected light and project on the wafer 106. Accordingly, the pattern on the mask 102 is transferred to the wafer 106.

The region 108 between the mask 102 and the projection lens 104 of the conventional stepper 102, however, is air. The diffracted angle of the diffracted light 100b, which is formed after the parallel light 100a passes through the mask 102, is thereby too large. Therefore, the diffracted light 100b, near the periphery of the projection lens 104, passes to the outside of the projection lens 104 and fails to project on the wafer 106. As a result, the amount of light received by the projection lens 104 is reduced and the exposure resolution is affected.

### SUMMARY OF THE INVENTION

The present invention provides a method to improve the resolution limits of a stepper.

The present invention provides a method to improve the resolution limits of a stepper. After passing through the mask, the diffraction angle of the diffracted light is reduced to allow more diffracted light to pass through the projection lens.

The present invention provides a method to improve the resolution limits of a stepper, wherein a majority of the diffracted light can pass through the projection lens to improve the resolution limits of a stepper.

The present invention provides a method to improve the resolution limits of a stepper, and the stepper includes a light source, a mask and a projection lens, wherein the mask is placed between the light source and the projection lens. A transparent material is then filled the region between the lens and the mask. The reflective index of the transparent material is greater than that of air (greater than 1), wherein the transparent material is, for example, air or a gel material. By filling the region between the mask and the projection lens with a transparent material, the diffraction angle of the diffracted light, formed after the parallel light passes through the mask, is reduced. More of the diffracted light thus passes through the projection lens to reduce the extent of the diffracted light to pass to the outside of the periphery of the projection lens. The resolution limits of the stepper is thus improved to have a smaller line-width and to enhance the manufacturing capability.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an illustration of a conventional projection exposure type of stepper; and

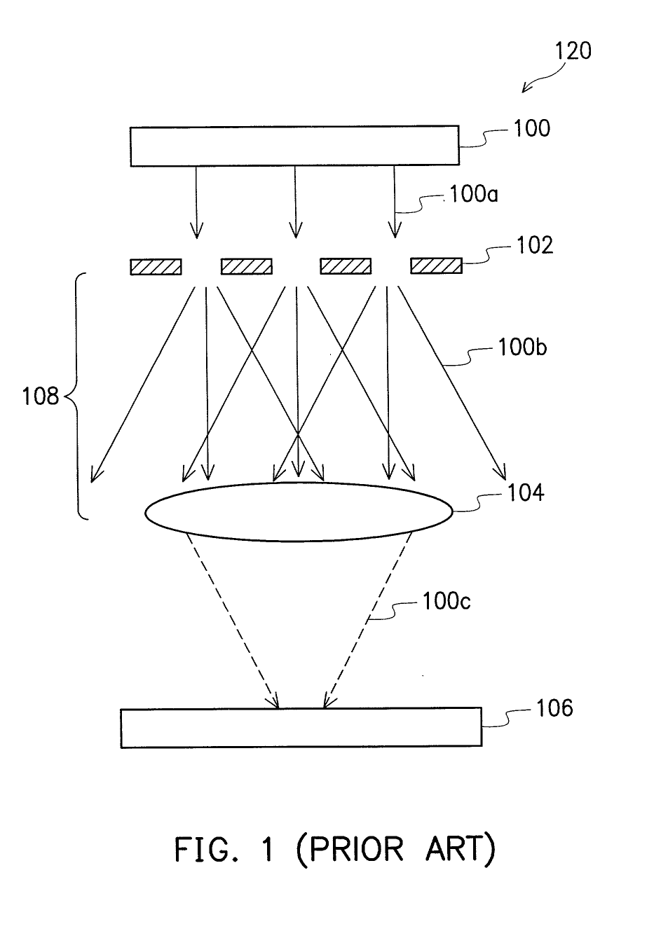

FIG. 2 illustrates the method for improving the resolution limits of a stepper.

### DESCRIPTION OF THE PREFERRED EMBODIMENTS

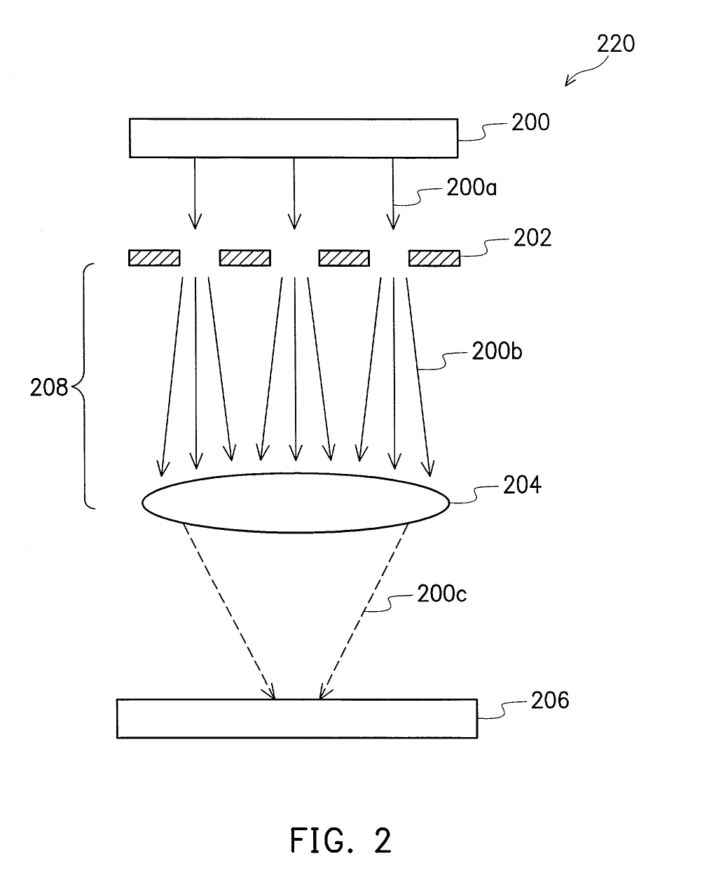

FIG. 2 illustrates the method for improving the resolution limits of a stepper.

Referring to FIG. 2, a stepper 220 is provided, wherein the stepper 220 includes a light source 200, a mask 202 and a projection lens 204. The light source 200 is formed with, for example, a mirror, a mercury arc lamp, a filter and a focal lens. The projection lens 204 is, for example, a reduction projection system.

The mask 202 is placed between the light source 200 and the projection lens 204. A parallel light 200a is generated from a light source 200. Since after passing through the mask 202, the parallel light 200a would pass through the projection lens 204 to reach the surface of the wafer 206. The pattern from the mask 204 is then transferred to the wafer 206.

However, the diffracted angle of the diffracted light 200b, formed after the parallel light passes through the mask 202, is too large. The diffracted light 200b near the periphery of the projection lens 204 therefore passes to the outside of the projection lens 104 and fails to project on the wafer 206.

Accordingly, the present invention provides a transparent material to fill the region 208 between the mask 202 and the projection lens 204. Since the reflection index of the transparent material is greater than the reflection index of air, in other words, the reflection index of the transparent material is greater than one. According to the law of reflection:

n₁ sin θ₁=n₂ sin θ₂

wherein,

n₁, n₁: the reflection index of the medium

θ₁: incident angle

θ₂: reflective angle

Based on the law of reflection, increasing the reflective index of the medium reduces the reflective angle of the light. Filling the region 208 between the mask 202 and the projection lens 204 with a transparent material with a reflective index greater than one thus reduce the diffraction angle of the diffracted light. The diffracted light that passes to the outside of the peripheral of the projection lens 204 is reduced to provide a better resolution limits of the exposure light.

The region 208 between the mask 202 and the projection lens 204 is filled with a transparent material, such as a gas or a gel. If filling the region 208 with the transparent material with a reflective index greater than one is a gas, the gas is, for example, argon. If filling the region 208 with the transparent material with a reflective index greater than one is a gel, the gel is, for example, the gelatinized form of ZnSe, Al₂O₃, SiO₂, C₆H₆ CS₂ or CCl₄.

Since the aforementioned transparent materials with a reflective index is greater than one, the diffraction angle of the diffracted light 200b is reduced, wherein the diffracted light 200b is formed after the parallel light 200a from a light source 200 passes through the mask 202. Accordingly, a majority of the diffracted light 200b near the periphery of the projection lens 204 passes through the projection lens, reducing the chances of the diffracted light to pass to the outside of the projection lens. The resolution limits of the stepper is thereby improved.

The present invention provides a method to improve the resolution limits of a stepper, wherein after passing through the mask, a majority of the diffracted light passes through the projection lens. By increasing the amount of the diffracted light to pass through the projection lens, the resolution limits of the stepper is thus improved. In other words, the line width can be reduced to enhance the manufacturing capability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for improving resolution limits of a stepper, comprising:
providing a stepper, wherein the stepper includes a light source, a mask and a projection lens, wherein the mask is placed between the light source and the projection lens; and
filling a region between the mask and the projection lens with a transparent material, wherein a reflection index of the transparent material is greater than that of air.

2. The method of claim 1, wherein the reflection index of the transparent material is greater than one.

3. The method of claim 2, wherein the transparent material is a gas.

4. The method of claim 3, wherein the gas includes argon.

5. The method of claim 2, wherein the transparent material includes a gel formed by gelatinizing a material.

6. The method of claim 5, wherein the material is selected from the group consisting of ZnSe, Al₂O₃, SiO₂, C₆H₆ CS₂ or CCl₄.

7. The method of claim 1, wherein the light source is formed with a mirror, a mercury arc lamp, a filter and a focal lens.

8. The method of claim 1, wherein the projection lens includes a reduction projection system.

9. A method to improve the resolution limits of a stepper by filling a region between the mask and the projection lens of the stepper with a medium, wherein a reflective index of the medium is greater than that of air.

10. The method of claim 9, wherein the reflective index of the medium is greater than one.

11. The method of claim 10, wherein the medium is a gas.

12. The method of claim 11, wherein the gas includes argon.

13. The method of claim 10, wherein the medium includes a gel formed by gelatinized a material.

14. The method of claim 13, wherein the material is selected from the group consisting of ZnSe, Al₂O₃, SiO₂, C₆H₆ CS₂ or CCl₄.

15. The method of claim 14, wherein the projection lens includes a reduction projection system.
